(19) United States
(12) Patent Application Publication
(10) Pub. No.: US 2026/0200803 A1
(43) Pub. Date: Jul. 16, 2026

(54) COMPOSITE SINTERED BODY

(71) Applicant: NGK INSULATORS, LTD., Nagoya-Shi (JP)

(72) Inventors: Tatsuki MINAMI, Takahama-Shi (JP); Tomohisa MIZOGUCHI, Ichinomiya-Shi (JP); Keita YAMANA, Nagoya-Shi (JP); Kazuhiro NOBORI, Handa-Shi (JP)

(73) Assignee: NGK INSULATORS, LTD., Nagoya-Shi (JP)

(21) Appl. No.: 19/562,933

(22) Filed: Mar. 11, 2026

Related U.S. Application Data
(63) Continuation of application No. PCT/JP2025/029397, filed on Aug. 21, 2025.

(30) Foreign Application Priority Data
Oct. 21, 2024 (JP) 2024-185038

(51) Int. Cl. C04B 35/581; C04B 35/443

(52) U.S. Cl. CPC C04B 35/581; C04B 35/443; C04B 2235/3865; C04B 2235/763; C04B 2235/85

(57) ABSTRACT

A composite sintered body includes aluminum nitride and spinel. The composite sintered body includes a plurality of crystal grains each containing aluminum nitride, and a grain boundary positioned between the crystal grains adjacent to each other out of the plurality of crystal grains. A thickness of at least part of the grain boundary is 0.6 nm or more.

### CROSS-REFERENCE TO RELATED APPLICATIONS

This application is a continuation under 35 U.S.C. 120 of International Application PCT/JP2025/029397 having the International Filing Date of Aug. 21, 2025 and having the benefit of the earlier filing date of Japanese Application No. 2024-185038, filed on Oct. 21, 2024. Each of the identified applications is fully incorporated herein by reference.

### BACKGROUND OF THE INVENTION

### 1. Field of the Invention

The present disclosure relates to a composite sintered body.

### 2. Description of the Related Art

It has heretofore been known that in the manufacture of a semiconductor device such as an integrated circuit, a semiconductor substrate supported by a susceptor is subjected to various kinds of treatment.

The susceptor typically includes: a ceramic substrate on which the semiconductor substrate can be mounted; and a conductor arranged inside the ceramic substrate. In the manufacture of the semiconductor device, when a voltage is applied to the conductor of the susceptor, the susceptor expresses a function (e.g., a heater function or an electrostatic chuck function) in accordance with applications.

As a material for forming the ceramic substrate included in such susceptor, for example, there has been proposed the composite sintered body including aluminum nitride and spinel, wherein the total percentage content of aluminum nitride and spinel in the composite sintered body is 95 wt % or more and 100 wt % or less, and wherein the percentage content of spinel in the composite sintered body is 15 wt % or more and 70 wt % or less (see Patent Literature 1).

### CITATION LIST

### Patent Literature

[PTL 1] JP 2019-167288 A

### SUMMARY OF THE INVENTION

In recent years, there has been a growing demand for the miniaturization of the semiconductor device. In view of the foregoing, in the manufacture of the semiconductor device, it has been required to perform various kinds of treatment on its semiconductor substrate with higher accuracy.

However, when a current leaks from the conductor included in the susceptor at the time of the application of a voltage to the conductor, there is a risk in that the susceptor cannot stably express a desired function (e.g., a heater function or an electrostatic chuck function), and hence the accuracy of each of the various kinds of treatment on the semiconductor substrate reduces.

Accordingly, a further improvement in volume resistivity of the material for forming the ceramic substrate of the susceptor has been expected.

A primary object of the present disclosure is to provide a composite sintered body that can achieve an improvement in volume resistivity.

[1] A composite sintered body according to one embodiment of the present disclosure includes aluminum nitride and spinel. The composite sintered body includes a plurality of crystal grains each containing aluminum nitride, and a grain boundary positioned between the crystal grains adjacent to each other out of the plurality of crystal grains. A thickness of at least part of the grain boundary is 0.6 nm or more.

[2] The composite sintered body according to the above-mentioned item [1] may further include an additive element. The additive element includes S, Y, Zr, C, Si, or a combination thereof.

[3] In the composite sintered body according to the above-mentioned item [2], the additive element may include Y. A content ratio of Y in the composite sintered body may be from 0.01 wt % to 0.1 wt %.

[4] In the composite sintered body according to the above-mentioned item [2], the additive element may include Y. An atomic ratio of Y in the grain boundary may be 0.5 atomic % or more.

[5] In the composite sintered body according to the above-mentioned item [2], the additive element may include S. A content ratio of S in the composite sintered body may be 200 ppm or more.

[6] In the composite sintered body according to the above-mentioned item [2], the additive element may include S. An atomic ratio of S in the grain boundary may be 0.5 atomic % or more.

[7] In the composite sintered body according to the above-mentioned item [2], the additive elements may include Y and S. A molar ratio Y/S in the grain boundary may be from 1.0 to 26.

[8] In the composite sintered body according to any one of the above-mentioned items [1] to [7], a content ratio of aluminum nitride in the composite sintered body may be 40 wt % or more and less than 70 wt %, and a content ratio of spinel in the composite sintered body may be 30 wt % or more and less than 60 wt %.

According to the embodiment of the present disclosure, an improvement in volume resistivity of the composite sintered body can be achieved.

### BRIEF DESCRIPTION OF THE DRAWINGS

FIG. 1 is a schematic configuration view of a composite sintered body according to one embodiment of the present disclosure.

FIG. 2 is a schematic sectional view of a susceptor including a ceramic substrate including the composite sintered body of FIG. 1.

FIG. 3 is a high-angle annular dark-field scanning transmission electron microscope (HAADF-STEM) image of a composite sintered body of Example 1.

FIG. 4 is a brightness profile of the HAADF-STEM image of FIG. 3.

FIG. 5 is a bright-field scanning transmission electron microscope (BF-STEM) image of the composite sintered body of Example 1.

FIG. 6 is a HAADF-STEM image of a composite sintered body of Example 2.

FIG. 7 is a brightness profile of the HAADF-STEM image of FIG. 6.

FIG. 8 is a BF-STEM image of the composite sintered body of Example 2.

FIG. 9 is a HAADF-STEM image of a composite sintered body of Comparative Example 1.

FIG. 10 is a brightness profile of the HAADF-STEM image of FIG. 9.

FIG. 11 is a BF-STEM image of the composite sintered body of Comparative Example 1.

### DESCRIPTION OF THE EMBODIMENTS

Embodiments of the present disclosure are described below. However, the present disclosure is not limited to these embodiments. In addition, for clearer illustration, some widths, thicknesses, shapes, and the like of respective portions may be schematically illustrated in the drawings in comparison to the embodiments. However, the widths, the thicknesses, the shapes, and the like are each merely an example, and do not limit the interpretation of the present disclosure.

### A. Overview of Composite Sintered Body

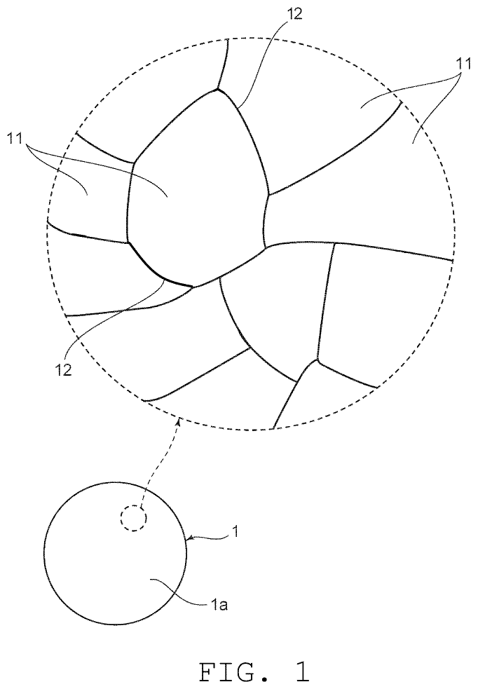

FIG. 1 is a schematic configuration view of a composite sintered body according to one embodiment of the present disclosure.

In one embodiment, a composite sintered body 1 includes aluminum nitride (AlN) and spinel (MgAl₂O₄). The composite sintered body 1 includes: a plurality of crystal grains 11; and a grain boundary 12 positioned between the crystal grains 11 adjacent to each other out of the plurality of crystal grains 11. Each of the plurality of crystal grains 11 contains aluminum nitride. In other words, the composite sintered body 1 has a polycrystalline structure containing the plurality of crystal grains 11. The crystal grains 11 adjacent to each other out of the plurality of crystal grains 11 are bonded to each other, and the grain boundary 12 is formed therebetween. The average particle diameter of the plurality of crystal grains 11 is, for example, from 0.5 μm to 8 μm, preferably from 1 μm to 5 μm. The thickness of at least part of the grain boundary 12 is 0.6 nm or more.

The inventors have discovered that the thickness of a grain boundary positioned between crystal grains in a composite sintered body including aluminum nitride and spinel affects the volume resistivity of the composite sintered body. In view of the foregoing, the inventors have made extensive investigations on the thickness of the grain boundary, and as a result, have found that when the thickness of at least part of the grain boundary is set to a predetermined value or more, the volume resistivity of the composite sintered body can be increased. More specifically, in one embodiment, the thickness of at least part of the grain boundary included in the composite sintered body 1 is 0.6 nm or more, and hence the volume resistivity of the composite sintered body in a high-temperature region can be sufficiently improved.

The volume resistivity of the composite sintered body 1 at 700° C. is, for example, more than 2.0×10⁹ Ω·cm, preferably 2.3×10⁹ Ω·cm or more, more preferably 3.0×10⁹ Ω·cm or more, still more preferably 5.0×10⁹ Ω·cm or more, particularly preferably 8.0×10⁹ Ω·cm or more.

Meanwhile, the volume resistivity of the composite sintered body 1 at 700° C. is, for example, 1.0×10¹² Ω·cm or less, or for example, 1.5×10¹¹ Ω·cm or less.

The volume resistivity of the composite sintered body at 700° C. is measured in conformity with JIS C2141-1992, for example.

The thickness of at least part of the grain boundary 12 is preferably 0.65 nm or more, more preferably 0.70 nm or more, still more preferably 0.80 nm or more, still further more preferably 0.90 nm or more, particularly preferably 1.0 nm or more. When the grain boundary has such thickness, the volume resistivity of the composite sintered body can be stably adjusted within the above-mentioned ranges.

Meanwhile, the upper limit of the thickness of at least part of the grain boundary 12 is typically 2.0 nm or less.

The thickness of the grain boundary is measured from, for example, a brightness profile in a HAADF-STEM image. More with specifically, the thickness is measured in conformity Examples to be described later.

The ratio of a portion having a thickness of 0.6 nm or more in the grain boundary 12 is, for example, 10% or more, preferably 50% or more, more preferably 80% or more. Meanwhile, the upper limit of the ratio of the portion having a thickness of 0.6 nm or more in the grain boundary 12 is typically 100%.

When the ratio of the portion having a thickness of 0.6 nm or more in the grain boundary falls within such ranges, the volume resistivity of the composite sintered body in a high-temperature region can be stably improved.

In one embodiment, the thicknesses of all the grain boundaries included in the composite sintered body 1 are 0.6 nm or more.

As described above, the composite sintered body 1 includes aluminum nitride (AlN) and spinel (MgAl₂O₄). In other words, the composite sintered body 1 includes an AlN crystal phase and a spinel crystal phase.

The content ratio of aluminum nitride in the composite sintered body 1 is, for example, 30 wt % or more, preferably 40 wt % or more, more preferably 50 wt % or more. Meanwhile, the content ratio of aluminum nitride in the composite sintered body 1 is, for example, less than 80 wt %, preferably less than 70 wt %, more preferably less than 60 wt %.

The content ratio of spinel in the composite sintered body 1 is, for example, 20 wt % or more, preferably 30 wt % or more, more preferably 40 wt % or more. Meanwhile, the content ratio of spinel in the composite sintered body 1 is, for example, 70 wt % or less, preferably 60 wt % or less, more preferably less than 50 wt %. In one embodiment, the content ratio of spinel in the composite sintered body 1 is smaller than the content ratio of aluminum nitride therein.

The content ratio of each of the crystal phases in the composite sintered body is measured by, for example, X-ray diffraction (XRD) in conformity with JIS Z2201 and JIS K0114.

The AlN crystal phase is typically positioned in each of the crystal grains 11. In other words, each of the plurality of crystal grains 11 contains the AlN crystal phase.

The spinel crystal phase is typically positioned in the grain boundary 12. In other words, the grain boundary 12 contains the spinel crystal phase. The spinel crystal phase may be present in each of the crystal grains 11 in addition to the grain boundary 12.

The content ratio of Al in the composite sintered body 1 is, for example, from 30 wt % to 60 wt %, preferably from 40 wt % to 50 wt %.

In addition, the content ratio of Mg in the composite sintered body 1 is, for example, from 2 wt % to 20 wt %, preferably from 5 wt % to 10 wt %.

The content ratio of a compositional element in the composite sintered body is measured by, for example, inductively coupled plasma atomic emission spectroscopy (ICP-AES) in conformity with JIS K0116.

In one embodiment, the composite sintered body: further includes an additive element in addition to aluminum nitride and spinel. Examples of the additive element include sulfur(S), yttrium (Y), zirconium (Zr), carbon (C), and silicon (Si). The additive elements may be used alone or in combination thereof. When the composite sintered body includes such additive element, the thickness of the grain boundary can be stably adjusted within the above-mentioned ranges.

The content ratio of the additive element in the composite sintered body 1 is, for example, from 0 wt % to 2.5 wt %, preferably from 0.001 wt % to 1.0 wt %.

The additive element is typically present in the grain boundary 12. The additive element may be present in each of the crystal grains 11 in addition to the grain boundary 12.

In one embodiment, the grain boundary 12 includes elements derived from aluminum nitride (Al and N), elements derived from spinel (Mg, Al, and O), and the additive element.

The atomic ratio of Al in the grain boundary 12 is, for example, from 40 atomic % to 70 atomic %, preferably from 50 atomic % to 60 atomic %.

The atomic ratio of Mg in the grain boundary 12 is, for example, from 1 atomic % to 10 atomic %, preferably from 2 atomic % to 5 atomic %.

The atomic ratio of the additive element in the grain boundary 12 is, for example, from 0 atomic % to 10 atomics, preferably from 1 atomic % to 7 atomic %, more preferably from 2 atomic % to 5 atomic %.

The atomic ratio of the compositional element in the grain boundary is measured by, for example, energy dispersive X-ray spectroscopy (EDS). More specifically, the atomic ratio is measured in conformity with a method described in Examples.

The additive element preferably includes Y and/or S. When the additive element includes Y and/or S, the thickness of the grain boundary can be more stably adjusted within the above-mentioned ranges. In particular, when the additive elements include Y and S in combination, the thickness of the grain boundary can be sufficiently increased.

The content ratio of Y in the composite sintered body 1 is, for example, 0 wt % or more, preferably 0.010 wt % or more, more preferably 0.030 wt % or more. Meanwhile, the content ratio of Y in the composite sintered body 1 is, for example, 0.2 wt % or less, preferably 0.100 wt % or less, more preferably 0.050 wt % or less.

When the content ratio of Y in the composite sintered body falls within such ranges, the volume resistivity of the composite sintered body can be stably increased.

In addition, the atomic ratio of Y in the grain boundary 12 is, for example, 0 atomic % or more, preferably 0.2 atomic % or more, more preferably 0.5 atomic % or more, still more preferably 1.0 atomic % or more. Meanwhile, the atomic ratio of Y in the grain boundary 12 is, for example, 5 atomic % or less, preferably 3.0 atomic % or less, more preferably 2.5 atomics or less.

When the atomic ratio of Y in the grain boundary falls within such ranges, the volume resistivity of the composite sintered body can be more stably increased.

The content ratio of S in the composite sintered body 1 is, for example, 0 ppm by weight or more, preferably 200 ppm by weight or more, more preferably 250 ppm by weight or more. Meanwhile, the content ratio of S in the composite sintered body 1 is, for example, 600 ppm by weight or less, preferably 500 ppm by weight or less, more preferably 350 ppm by weight or less.

When the content ratio of S in the composite sintered body falls within such ranges, the volume resistivity of the composite sintered body can be even more stably increased.

In addition, the atomic ratio of S in the grain boundary 12 is, for example, 0 atomic % or more, preferably 0.1 atomic % or more, more preferably 0.5 atomic % or more, still more preferably 0.7 atomic % or more. Meanwhile, the atomic ratio of S in the grain boundary 12 is, for example, 3 atomic % or less, preferably 2.0 atomic or less, more preferably 1.5 atomics or less.

When the atomic ratio of S in the grain boundary falls within such ranges, the volume resistivity of the composite sintered body can be significantly increased.

When the additive elements include Y and S, the molar ratio (S/Y) of S to Y in the composite sintered body 1 is, for example, from 0.01 to 1.5, preferably from 0.1 to 1.0, more preferably from 0.6 to 0.8.

In addition, the molar ratio (S/Y) of S to Y in the grain boundary 12 is, for example, from 0.01 to 1.5, preferably from 0.2 to 1.0, more preferably from 0.3 to 1.0, still more preferably from 0.3 to 0.9. In other words, the molar ratio (Y/S) of Y to S in the grain boundary 12 is, for example, from 0.6 to 100, preferably from 1.0 to 26, more preferably from 1.0 to 5.0, still more preferably from 1.1 to 4.0.

When the molar ratio between Y and S falls within such ranges, a composite sintered body having the above-mentioned volume resistivity can be stably achieved.

In one embodiment, the additive elements include Zr in addition to Y and/or S.

The content ratio of Zr in the composite sintered body 1 is, for example, from 0 wt % to 3 wt %, preferably from 0.10 wt % to 1.00 wt %, more preferably from 0.50 wt % to 0.80 wt %.

The molar ratio (Zr/Y) of Zr to Y in the composite sintered body 1 is, for example, from 0 to 40, preferably from 1 to 35, more preferably from 5 to 30, still more preferably from 10 to 20.

The molar ratio (Zr/S) of Zr to S in the composite sintered body 1 is, for example, from 0 to 50, preferably from 5 to 40, more preferably from 10 to 30.

In addition, the atomic ratio of Zr in the grain boundary 12 is, for example, from 0 atomic % to 1.0 atomic %, preferably from 0.05 atomic % to 0.5 atomic %, more preferably from 0.05 atomic % to 0.3 atomic %.

The porosity of such composite sintered body 1 is, for example, 1.0% or less. The porosity of the composite sintered body is measured in conformity with JIS R1634, for example.

The relative density of the composite sintered body 1 is, for example, 99.0% or more, preferably 99.5% or more. Meanwhile, the upper limit of the relative density of the composite sintered body 1 is typically 100%. The relative density of the composite sintered body is measured in conformity with JIS R1634, for example.

### B. Method of Manufacturing Composite Sintered Body

Next, a method of manufacturing a composite sintered body according to one embodiment is described.

A method of manufacturing the composite sintered body 1 includes: a mixing step of mixing raw material powders for the composite sintered body 1; a molding step of preparing a molded body from the raw material mixture obtained in the mixing step; and a firing step of firing the molded body.

### B-1. Mixing Step

In one embodiment, in the mixing step, an aluminum nitride raw material (hereinafter referred to as “AlN raw material”) and a spinel raw material are mixed to prepare a raw material mixture.

The AlN raw material contains aluminum nitride (AlN) as a main component. The AlN raw material may contain oxygen and carbon in addition to AlN.

The amount of oxygen in the AlN raw material is, for example, from 0.7 wt % to 0.9 wt %. The amount of carbon in the AlN raw material is, for example, from 200 ppm by weight to 400 ppm by weight.

The AlN raw material typically has a powdery form. The average particle diameter D50 of the AlN raw material is, for example, from 1.0 μm to 1.5 μm.

The spinel raw material contains spinel (MgAl₂O₄) as a main component.

In one embodiment, the spinel raw material contains the above-mentioned additive element in addition to spinel. When the spinel raw material contains the additive element, the thickness of a grain boundary in the composite sintered body to be manufactured can be stably adjusted within the above-mentioned ranges.

The atomic ratio of the additive element in the spinel raw material is, for example, from 10 ppm by weight to 2,000 ppm by weight, preferably from 300 ppm by weight to 1, 500 ppm by weight, more preferably from 1,000 ppm by weight to 1, 400 ppm by weight.

The spinel raw material preferably contains S as an additive element. In addition, the spinel raw material may further contain Si and C as additive elements.

The atomic ratio of S in the spinel raw material is, for example, from 10 ppm by weight to 1, 500 ppm by weight, preferably from 400 ppm by weight to 1,200 ppm by weight, more preferably from 600 ppm by weight to 1,000 ppm by weight.

The spinel raw material typically has a powdery form. The average particle diameter D50 of the spinel raw material is, for example, from 0.2 μm to 0.8 μm.

The addition amount of the spinel raw material is, for example, from 50 parts by weight to 100 parts by weight, preferably from 70 parts by weight to 90 parts by weight with respect to 100 parts by weight of the AlN raw material.

In the mixing step, a zirconia raw material may be further added to the raw material mixture. Thus, the thickness of the grain boundary can be more stably adjusted within the above-mentioned ranges.

The zirconia raw material contains zirconia (ZrO₂) as a main component.

The content ratio of zirconia in the zirconia raw material is, for example, from 80 mol % to 100 mol %, and is, for example, from 90 mol % to 99 mol %, preferably from 95 mol % to 98 mol %.

In one embodiment, the zirconia raw material contains the above-mentioned additive element in addition to zirconia. When the zirconia raw material contains the additive element, the thickness of the grain boundary can be even more stably adjusted within the above-mentioned ranges. The zirconia raw material preferably contains Y as an additive element. More specifically, the zirconia raw material contains yttria (Y₂O₃).

The content ratio of yttria in the zirconia raw material is, for example, from 1 mol % to 10 mol %, preferably from 2 mol % to 4 mol %.

The zirconia raw material typically has a powdery form. The average particle diameter D50 of the zirconia raw material is, for example, from 0.2 μm to 1.0 μm.

The addition amount of the zirconia raw material is, for example, from 0.1 part by weight to 3.0 parts by weight, preferably from 0.5 part by weight to 1.5 parts by weight with respect to 100 parts by weight of the total sum of the AlN raw material and the spinel raw material.

Any appropriate mixing device may be used in the mixing step. Examples of the mixing device include a ball mill, a bead mill, a vibration mill, a rocking mixer, a blender, and a homogenizer.

A mixing method may be dry mixing or wet mixing. In one embodiment, the wet mixing is performed in the mixing step. Any appropriate organic solvent is used in the wet mixing.

Environmental conditions in the mixing step are not particularly limited. The mixing step is typically performed under normal temperature (23° C.) and normal pressure (0.1 MPa).

A mixing time is freely and appropriately set. The mixing time is, for example, from 1 hour to 24 hours.

Thus, a raw material mixture is prepared. When the mixing step is dry mixing, the raw material mixture has a powdery form. When the mixing step is wet mixing, the raw material mixture has a slurry form.

### B-2. Granulation Step

In one embodiment, the method of manufacturing the composite sintered body 1 includes a granulation step after the mixing step and before the molding step.

In the granulation step, the raw material mixture obtained in the mixing step is granulated by any appropriate granulation method. Examples of the granulation method include spray granulation and tumbling granulation. Of those, spray granulation is preferred.

Thus, a granulated product (hereinafter referred to as “raw material granules”) of the raw material mixture is prepared.

### B-3. Molding Step

Next, in the molding step, the raw material mixture (preferably raw material granules) is molded into a desired shape by any appropriate molding method to prepare a molded body.

Examples of the molding method include press molding, sheet molding, and cold isostatic pressing (CIP), and doctor blade molding. Of those, press molding is preferred. A pressure in the press molding is, for example, from 10 kgf/cm² to 500 kgf/cm².

Thus, a molded body having a desired shape is prepared.

### B-4. Firing Step

Next, in the firing step, the molded body is typically fired under a vacuum or a non-oxidizing atmosphere. More specifically, the temperature is increased from normal temperature (23° C.) to a predetermined firing temperature, and the firing temperature is then maintained for a predetermined firing time.

The firing temperature is, for example, from 1,600° C. to 1,900° C., preferably from 1,650° C. to 1, 850° C.

The firing time is, for example, from 0.5 hour to 100 hours.

An ambient pressure in the firing step is, for example, from 100 kPa to 900 kPa.

Examples of the firing method include hot pressing and hot isostatic pressing (HIP). Of those, hot pressing is preferred.

In the hot pressing, the molded body is typically arranged in a hot pressing die (e.g., a carbon jig), heated to the firing temperature as described above, and pressed under a predetermined pressure. A pressure in the hot pressing is, for example, from 5 MPa to 50 MPa.

In such firing step, aluminum nitride incorporated into the molded body is sintered to form the plurality of crystal grains 11 and the grain boundary 12 positioned between the crystal grains 11. In addition, in one embodiment, in the firing step, spinel (Mg) and the additive element smoothly move inside the molded body to reach the grain boundary 12. Thus, the thickness of the grain boundary 12 is stably adjusted within the above-mentioned ranges.

Thus, the composite sintered body 1 is manufactured.

### C. Application of Composite Sintered Body

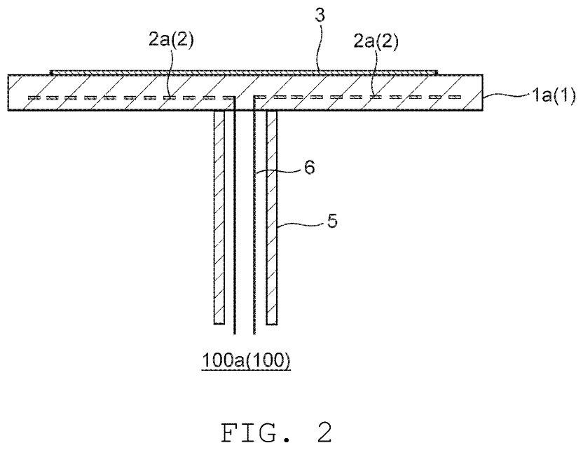

As illustrated in FIG. 2, the composite sintered body 1 is typically applied to a part (member 100 for semiconductor manufacture) for a semiconductor manufacturing apparatus for manufacturing a semiconductor device. The member 100 for semiconductor manufacture is a device that can be distributed alone and is industrially applicable. Examples of the member 100 for semiconductor manufacture include a susceptor, a heater, an electrostatic chuck, a ceramic conductor, a feed terminal, and a showerhead.

In one embodiment, the composite sintered body 1 is applied to a susceptor 100a.

The susceptor 100a typically includes: a ceramic substrate 1a including the composite sintered body 1; and a conductor 2.

The ceramic substrate 1a functions as a substrate mounting plate on which a semiconductor substrate 3 can be mounted.

The ceramic substrate 1a has any appropriate shape. In the illustrated example, the ceramic substrate 1a has a disc shape (see FIG. 1).

The thickness of the ceramic substrate 1a is, for example, from 10 mm to 50 mm.

The conductor 2 is arranged inside the ceramic substrate 1a. In other words, the conductor 2 is embedded in the ceramic substrate 1a.

The conductor 2 typically includes a conductive material having a volume resistivity smaller than that of the composite sintered body 1.

Examples of such conductive material include: metal carbide compounds such as tungsten carbide (WC); metal nitride compounds such as titanium nitride (TiN); and transition metals, such as molybdenum (Mo), tantalum (Ta), tungsten (W), platinum (Pt), rhenium (Re), and hafnium (Hf). The conductive materials may be used alone or in combination thereof.

The thickness of the conductor 2 (dimension thereof in the thickness direction of the ceramic substrate 1a) is, for example, from 10 μm to 50 μm, preferably from 20 μm to 30 μm.

The number of elements of the conductor 2 to be arranged in the ceramic substrate 1a is not particularly limited. A plurality of conductors 2 may be arranged in the ceramic substrate 1a. In this case, the plurality of conductors 2 are positioned at a distance from each other in the thickness direction of the ceramic substrate 1a.

The conductor 2 has any appropriate function in accordance with the applications of the susceptor 100a. Examples of the conductor 2 include a resistance heating element, an ESC electrode, and a RF electrode.

In one embodiment, the conductor 2 functions as a resistance heating element 2a. The resistance heating element 2a is configured to generate heat when a voltage is applied thereto.

The resistance heating element 2a has any appropriate shape. Examples of the shape of the resistance heating element 2a include a coil shape, a zigzag shape, and a mesh shape.

The ceramic substrate 1a having embedded therein the conductor 2 is manufactured by, for example, embedding the conductor 2 (or a precursor of the conductor) in the molded body including the raw material mixture at a desired position in the above-mentioned molding step and firing the resultant in the above-mentioned firing step.

In the illustrated example, the susceptor 100a includes a ceramic shaft 5 and a power feeding rod 6 in addition to the ceramic substrate 1a and the conductor 2.

The ceramic shaft 5 can support the ceramic substrate 1a. The ceramic shaft 5 is connected to the surface of the ceramic substrate 1a on the side opposite to the surface on which the semiconductor substrate is mounted.

The ceramic shaft 5 has any appropriate shape. In one embodiment, the ceramic shaft 5 has a cylindrical shape extending in the thickness direction of the ceramic substrate 1a.

The ceramic shaft 5 includes any appropriate ceramic material. The ceramic shaft 5 preferably includes the composite sintered body 1. When the ceramic shaft and the ceramic substrate contain the same composite sintered body, a difference in thermal expansion between the ceramic substrate and the ceramic shaft can be reduced, and hence bonding strength between the ceramic substrate and the ceramic shaft under a high temperature environment can be sufficiently secured.

The power feeding rod 6 is electrically connected to the conductor 2. In the illustrated example, the power feeding rod 6 is electrically connected to the resistance heating element 2a through the internal space of the ceramic shaft 5. The power feeding rod 6 includes any appropriate conductive material. A voltage may be applied to the conductor 2 through the power feeding rod 6.

In such member 100 for semiconductor manufacture (susceptor 100a), the grain boundary 12 (see FIG. 1) in the composite sintered body 1 has the above-mentioned thickness, and the ceramic substrate 1a includes the composite sintered body 1. Accordingly, the volume resistivity of the ceramic substrate 1a can be sufficiently improved.

Accordingly, when a voltage is applied to the conductor 2 through the power feeding rod 6, a current can be suppressed from leaking from the conductor 2, and hence the member 100 for semiconductor manufacture can stably express a desired function (e.g., a heater function or an electrostatic chuck function).

As a result, the semiconductor substrate 3 can be subjected to various kinds of treatment with high accuracy, and hence the miniaturization of a semiconductor device to be manufactured can be achieved.

### EXAMPLES

The present disclosure is specifically described below by way of Examples and Comparative Example. However, the present disclosure is by no means limited by these Examples. Measurement methods for characteristics are as described below.

### (1) Measurement of Thickness of Grain Boundary in

### Composite Sintered Body

Composite sintered bodies manufactured in Examples and Comparative Example were each cut into a test piece measuring 5 mm by 5 mm. The test piece had a thickness of 1 mm.

Next, the test piece was thinned into a size suitable for a HAADF-STEM detector, and the test piece was analyzed with the HAADF-STEM detector under the following conditions.

### <Analysis Conditions>

Apparatus: JEM-ARM200F manufactured by JEOL Ltd.
Acceleration voltage: 200 kV
Magnification: 10,000,000
Beam diameter: about 0.2 nm

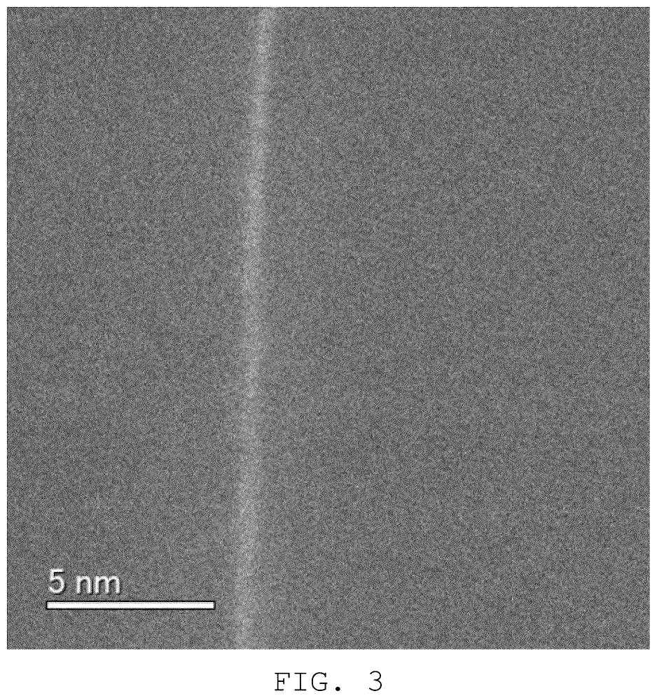

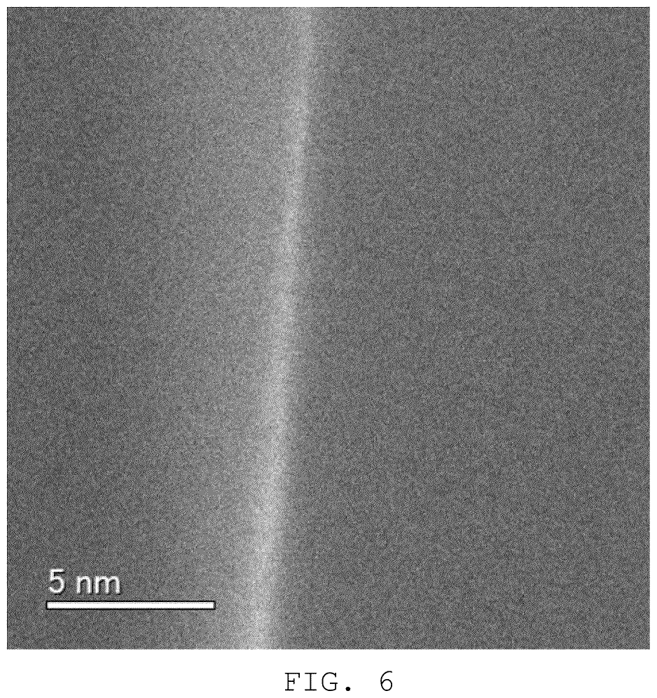

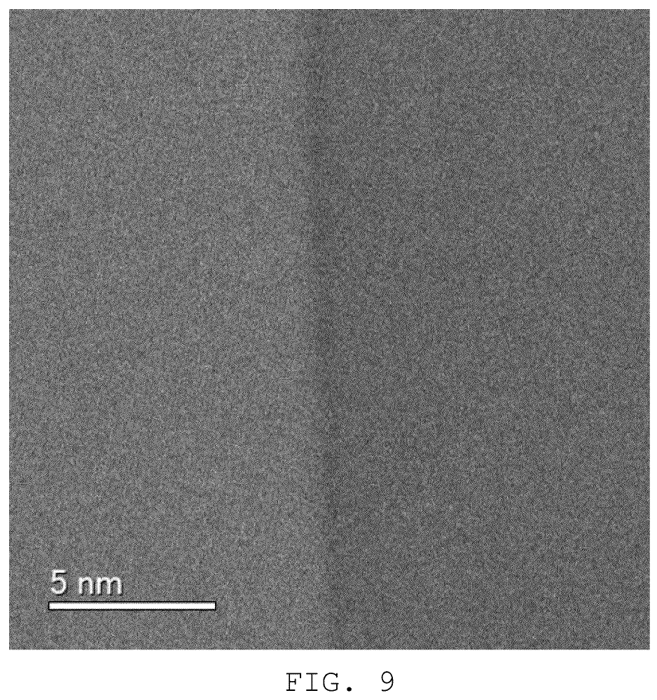

Thus, a HAADF-STEM image of each of the composite sintered bodies was obtained. The HAADF-STEM image of the composite sintered body of Example 1 is shown in FIG. 3, the HAADF-STEM image of the composite sintered body of Example 2 is shown in FIG. 6, and the HAADF-STEM image of the composite sintered body of Comparative Example 1 is shown in FIG. 9.

Next, a brightness profile of a linear region perpendicular to a grain boundary in the HAADF-STEM image of each of the composite sintered bodies was obtained. A length measurement end portion was determined on the basis of a half-value point (site) in the brightness profile of the HAADF-STEM image through use of, for example, whether or not the site coincided with an inflection point of the brightness profile and/or an amorphous site in a bright-field (BF) image of the composite sintered body as evidence for judging.

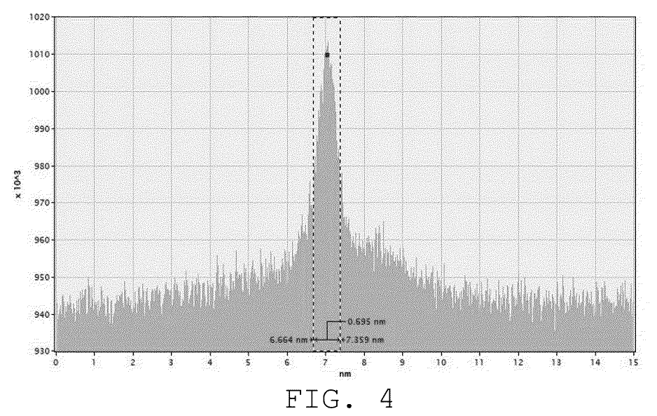

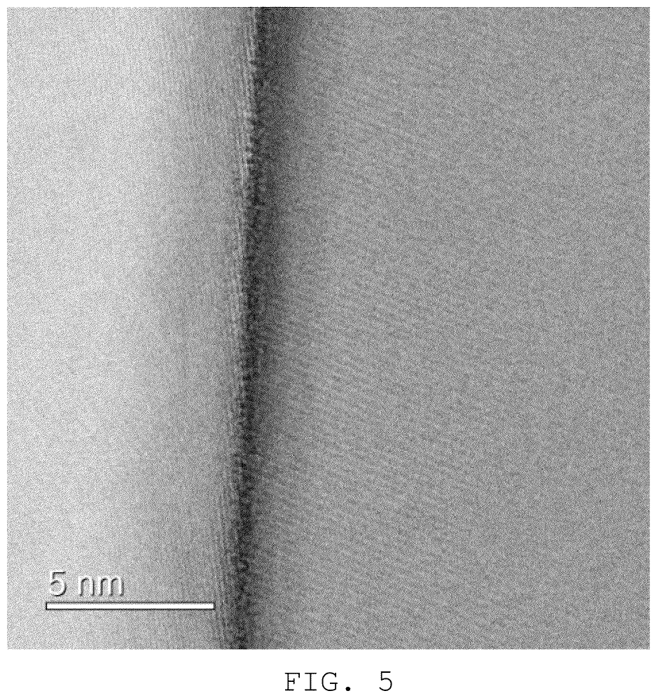

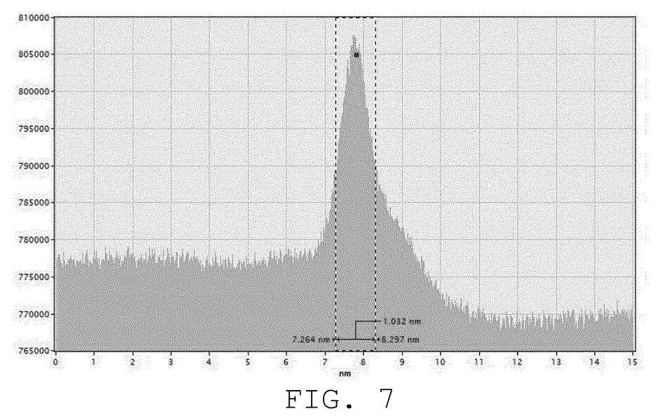

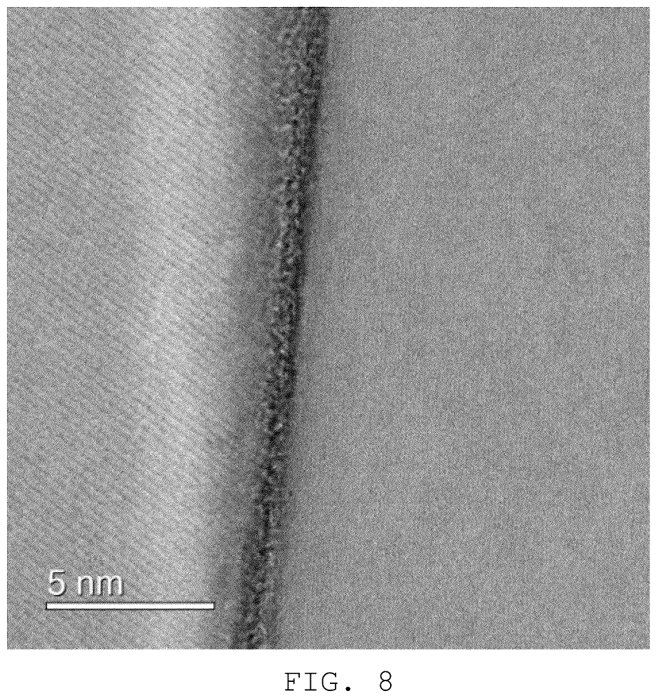

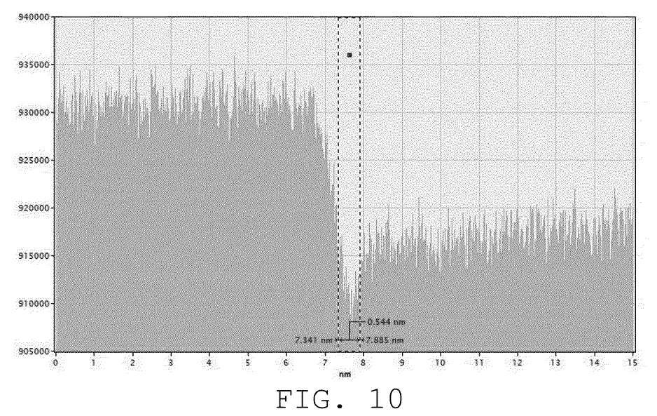

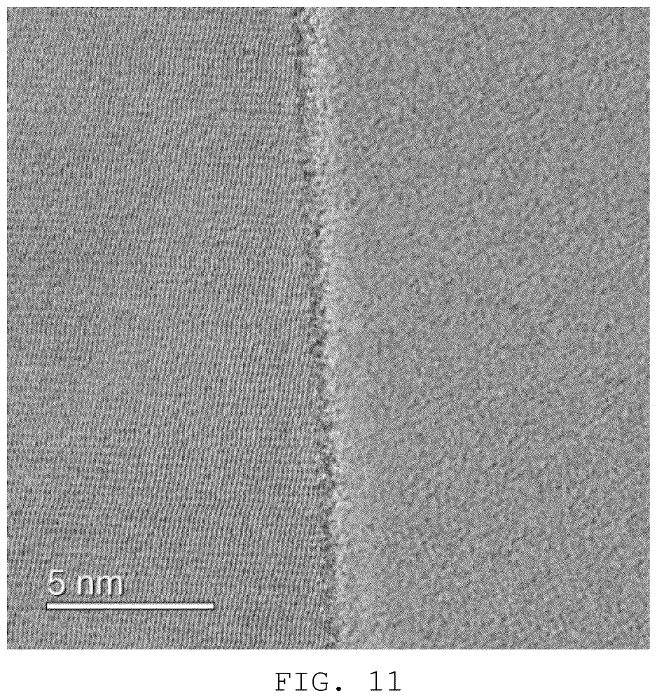

The brightness profile of the composite sintered body of Example 1 is shown in FIG. 4, and the BF-STEM image of the composite sintered body of Example 1 is shown in FIG. 5. The brightness profile of the composite sintered body of Example 2 is shown in FIG. 7, and the BF-STEM image of the composite sintered body of Example 2 is shown in FIG. 8. The brightness profile of the composite sintered body of Comparative Example 1 is shown in FIG. 10, and the BF-STEM image of the composite sintered body of Comparative Example 1 is shown in FIG. 11.

After that, the half-value width (full width at half maximum) of a peak in each of the brightness profiles was defined as the thickness of the grain boundary. The results are shown in Table 2.

### (2) Measurement of Content Ratio of Compositional Element in Composite Sintered Body

The content ratio of a compositional element in each of the composite sintered bodies manufactured in Examples and Comparative Example was measured by inductively coupled plasma atomic emission spectroscopy (ICP-AES) in conformity with JIS K0116. The results are shown in Table 2.

### (3) Measurement of Atomic Ratio in Grain Boundary

A test piece was prepared in the same manner as in the above-mentioned section “(1) Measurement of Thickness of Grain Boundary in Composite Sintered Body.”

Next, a grain boundary positioned on the polished surface of the test piece was subjected to semi-quantitative analysis by energy dispersive X-ray spectroscopy (EDS) under the following conditions.

### <Analysis Conditions>

Apparatus: JEM-ARM200F manufactured by JEOL Ltd.
Acceleration voltage: 200 kV
Magnification: 10,000,000
Beam diameter: about 0.2 nmΦ

Thus, the atomic ratio of each of Zr, Y, and S in the grain boundary was measured. The measurement was repeated three times. The results are shown in Table 2.

### (4) Measurement of Volume Resistivity of Composite Sintered Body

The volume resistivity at 700° C. of each of the composite sintered bodies manufactured in Examples and Comparative Example was measured in conformity with JIS C2141. The results are shown in Table 2.

### Example 1

AlN raw material powder (average particle diameter D50: 1.2 μm, oxygen content: 0.8 wt %), first spinel raw material powder (average particle diameter D50: 0.5 μm), and zirconia raw material powder were loaded into a ball mill, and were subjected to dry mixing for 10 hours. The composition of the first spinel raw material powder is shown in Table 1. Three mole percent of yttria (Y₂O₃) was added as a stabilizer to the zirconia raw material powder.

Thus, mixed powder (raw material mixture) was obtained. After that, the mixed powder was granulated by spray drying.

Next, the granules of the mixed powder were loaded into a predetermined die, and were uniaxially pressed to provide a molded body having a disc shape. A pressure in the uniaxial pressing was 100 kgf/cm².

Next, the molded body was fired by hot pressing. More specifically, the molded body was fired under a nitrogen atmosphere at 1,800° C. for 2 hours.

Thus, there was manufactured a composite sintered body including: a plurality of crystal grains each containing AlN; and a grain boundary positioned between the crystal grains adjacent to each other.

### Example 2

A composite sintered body was manufactured in the same manner as in Example 1 except that the first spinel raw material powder was changed to second spinel raw material powder. The composition of the second spinel raw material powder is shown in Table 1.

### Comparative Example 1

A composite sintered body was manufactured in the same manner as in Example 1 except that the zirconia raw material powder was not added to the mixed powder (raw material mixture).

TABLE 1

| | | First spinel raw | Second spinel raw |
|---|---|---|---|
| | | material powder | material powder |
| Mg | [wt %] | 16.6 | 16.8 |
| Al | [wt %] | 38.2 | 37.95 |
| Si | [ppm] | 20 | 20 |
| C | [ppm] | 400 | 400 |
| Fe | [ppm] | 10 | <10 |
| Ca | [ppm] | <10 | 20 |
| K | [ppm] | <10 | 60 |
| Na | [ppm] | <10 | 20 |
| S | [ppm] | <100 | 800 |

TABLE 2

| | | | No. | | | | | | | | |
|---|---|---|---|---|---|---|---|---|---|---|---|
| | | | | | | | | | Comparative | | |
| | | | Example 1 | | | Example 2 | | | Example 1 | | |
| Content ratio of | Mg | [wt %] | 7.34 | | | 7.37 | | | 7.42 | | |
| compositional element | Y | [wt %] | 0.041 | | | 0.041 | | | <10 | | |
| of composite | Zr | [wt %] | 0.69 | | | 0.69 | | | <10 | | |
| sintered body | Al | [wt %] | — | | | — | | | — | | |
| | Si | [ppm] | 20 | | | 70 | | | 40 | | |
| | C | [ppm] | 300 | | | 300 | | | 100 | | |
| | Fe | [ppm] | <10 | | | <10 | | | <10 | | |
| | Ca | [ppm] | <10 | | | 10 | | | <10 | | |
| | K | [ppm] | <10 | | | <10 | | | <10 | | |
| | Na | [ppm] | <10 | | | <10 | | | <10 | | |
| | S | [ppm] | <100 | | | 300 | | | <100 | | |
| Atomic ratio | Round of measurement | | 1 | 2 | 3 | 1 | 2 | 3 | 1 | 2 | 3 |
| of grain | Zr | [atomic %] | 0.4 | ND | 0.2 | <0.1 | 0.1 | 0.2 | ND | ND | ND |
| boundary | Y | [atomic %] | 2.6 | 1.6 | 2.0 | 1.3 | 1.1 | 2.4 | ND | ND | ND |
| | S | [atomic %] | 0.1 | 0.1 | 0.1 | 1.1 | 0.7 | 0.8 | ND | ND | ND |

| | | | | | | | | | | |
|---|---|---|---|---|---|---|---|---|---|---|
| Y/S | [—] | 26 | 16 | 20 | 1.18 | 1.57 | 3.00 | — | — | — |

| | | | | |
|---|---|---|---|---|
| Thickness of grain | [nm] | 0.695 | 1.032 | 0.544 |
| boundary | | | | |
| Volume resistivity | [Ω · cm] | 2.4 × 10⁹ | 8.8 × 10⁹ | 5.5 × 10⁸ |
| (at 700° C.) | | | | |

### <Evaluation>

As shown in Table 2, it is found that when the thickness of the grain boundary positioned between the crystal grains adjacent to each other out of the plurality of crystal grains is 0.6 nm or more, the volume resistivity of the composite sintered body can be improved.

The composite sintered body according to the embodiment of the present disclosure is typically used in semiconductor manufacturing apparatus, and in particular, can be suitably used in, for example, a susceptor, a heater, an electrostatic chuck, a ceramic conductor, a feed terminal, or a showerhead.

What is claimed is:

1. A composite sintered body, comprising:
aluminum nitride;
spinel; and
an additive element,
wherein the composite sintered body comprises
a plurality of crystal grains each containing aluminum nitride, and
a grain boundary positioned between the crystal grains adjacent to each other out of the plurality of crystal grains,
wherein a thickness of at least part of the grain boundary is 0.6 nm or more, and
wherein the additive element includes Y, and a content ratio of Y in the composite sintered body is from 0.01 wt % to 0.1 wt %.

2. The composite sintered body according to claim 1, further comprising the additive element including S, Zr, C, Si, or a combination thereof.

3. The composite sintered body according to claim 2, wherein an atomic ratio of Y in the grain boundary is 0.5 atomic % or more.

4. The composite sintered body according to claim 2, wherein the additive element includes S, and a content ratio of S in the composite sintered body is 200 ppm or more.

5. The composite sintered body according to claim 2, wherein the additive element includes S, and an atomic ratio of S in the grain boundary is 0.5 atomic % or more.

6. The composite sintered body according to claim 2, wherein the additive elements include S, and a molar ratio Y/S in the grain boundary is from 1.0 to 26.

7. The composite sintered body according to claim 1,
wherein a content ratio of aluminum nitride in the composite sintered body is 40 wt % or more and less than 70 wt %, and
wherein a content ratio of spinel in the composite sintered body is 30 wt % or more and less than 60 wt %.
